(19) United States
(12) Patent Application Publication
(10) Pub. No.: US 2025/0317408 A1
(43) Pub. Date: Oct. 9, 2025

(54) FABRIC-BASED COMPUTE

(71) Applicant: Samsung Electronics Co., Ltd., Suwon-si (KR)

(72) Inventor: Marc Timothy JONES, Longmont, CO (US)

(21) Appl. No.: 18/895,378

(22) Filed: Sep. 24, 2024

Related U.S. Application Data
(60) Provisional application No. 63/631,780, filed on Apr. 9, 2024.

(51) Int. Cl. H04L 49/25; H04L 49/00

(52) U.S. Cl. CPC H04L 49/25; H04L 49/30

(57) ABSTRACT

A system is disclosed. A fabric may connect to a first device and a second device. The fabric may include a fabric component, the fabric component including a transformation function. The fabric component may receive a first packet originating from the first device, the first packet including a first data. The fabric component may execute the transformation function on the first data to generate a second data. The fabric component may send a second packet toward the second device, the second packet including the second data.

### RELATED APPLICATION DATA

This application claims the benefit of U.S. Provisional Patent Application Ser. No. 63/631,780, filed Apr. 9, 2024, which is incorporated by reference herein for all purposes.

### FIELD

The disclosure relates generally to computing, and more particularly to supporting processing along a fabric.

### BACKGROUND

Historically, all processing has been performed by the processor of the computer. This design choice results in the need to manage the load on the processor. As the amount of data to process grows, the processing load grows as well. Even with multi-core and multi-thread processors, the load on a processor continues to grow.

A need remains to improve management of the processing load.

### BRIEF DESCRIPTION OF THE DRAWINGS

The drawings described below are examples of how embodiments of the disclosure may be implemented, and are not intended to limit embodiments of the disclosure. Individual embodiments of the disclosure may include elements not shown in particular figures and/or may omit elements shown in particular figures. The drawings are intended to provide illustration and may not be to scale.

FIG. 1 shows a machine including a fabric supporting fabric-based computing, according to embodiments of the disclosure.

FIG. 2 shows details of the machine of FIG. 1, according to embodiments of the disclosure.

FIG. 3 shows an example architecture for the fabric of FIG. 1, according to embodiments of the disclosure.

FIG. 4 shows details of packets traversing the fabric of FIG. 1 being transformed, according to embodiments of the disclosure.

FIG. 5 shows various data that may be included in the packets of FIG. 4, according to embodiments of the disclosure.

FIG. 6 shows details of the fabric component of FIG. 3, according to embodiments of the disclosure.

FIG. 7 shows the fabric component of FIG. 3 keeping a connection active while executing the transformation function of FIG. 3, according to embodiments of the disclosure.

FIG. 8 shows a flowchart of an example procedure for the fabric component of FIG. 3 to execute the transformation function of FIG. 3 on the packets of FIG. 4, according to embodiments of the disclosure.

FIG. 9 shows a flowchart of an example procedure for the fabric component of FIG. 3 to advertise and use the contexts of FIG. 6, according to embodiments of the disclosure.

FIG. 10 shows a flowchart of an example procedure for the fabric component of FIG. 3 to select itself to execute the transformation function of FIG. 3 on the packets of FIG. 4, according to embodiments of the disclosure.

FIG. 11 shows a flowchart of an example procedure for the fabric component of FIG. 3 to keep a connection alive, according to embodiments of the disclosure.

### SUMMARY

A fabric component may receive a first data originating from a first device. The fabric component may execute a transformation function to generate a second data from the first data, and may send the second data on toward a second device.

### DETAILED DESCRIPTION

Reference will now be made in detail to embodiments of the disclosure, examples of which are illustrated in the accompanying drawings. In the following detailed description, numerous specific details are set forth to enable a thorough understanding of the disclosure. It should be understood, however, that persons having ordinary skill in the art may practice the disclosure without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first module could be termed a second module, and, similarly, a second module could be termed a first module, without departing from the scope of the disclosure.

The terminology used in the description of the disclosure herein is for the purpose of describing particular embodiments only and is not intended to be limiting of the disclosure. As used in the description of the disclosure and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

When computers first became popular, all processing was performed by the Central Processing Unit (CPU). As the amount of data to process was not necessarily that large, even the (relatively) slower processors of the day could manage the processing of the data.

But data has continued to grow, with modern personal computers easily storing 100,000 times, or more, data as early personal computers. Data centers are seeing even larger amounts of data to be stored. Even as processors have improved, become faster, adding cores and multi-thread capabilities, the burden on the processor has increased.

In addition, the amount of processing to be performed on data is increasing. For example, the large data models used in Artificial Intelligence (AI)/Machine Learning (ML) may require significant processing to be usable. In other words, not only is the amount of data to be processed growing, but so is the amount of processing to be performed on that data.

Embodiments of the disclosure address these problems by introducing new options for data processing other than in the processor. A computer includes a fabric, such as a Peripheral Component Interconnect Express (PCIe) fabric, that may connect processor and storage device (among other components). The fabric may include root complexes, switches, and endpoints, each of which may include a computing capability. Packets of data sent along the fabric may be associated with contexts, which may identify what processing is to occur to the data. The packets may then be transformed while travelling along the fabric, so that by the time the eventual data packets reach their destinations the data may already have been processed. This may result in less data being moved along the fabric, which may increase efficiency.

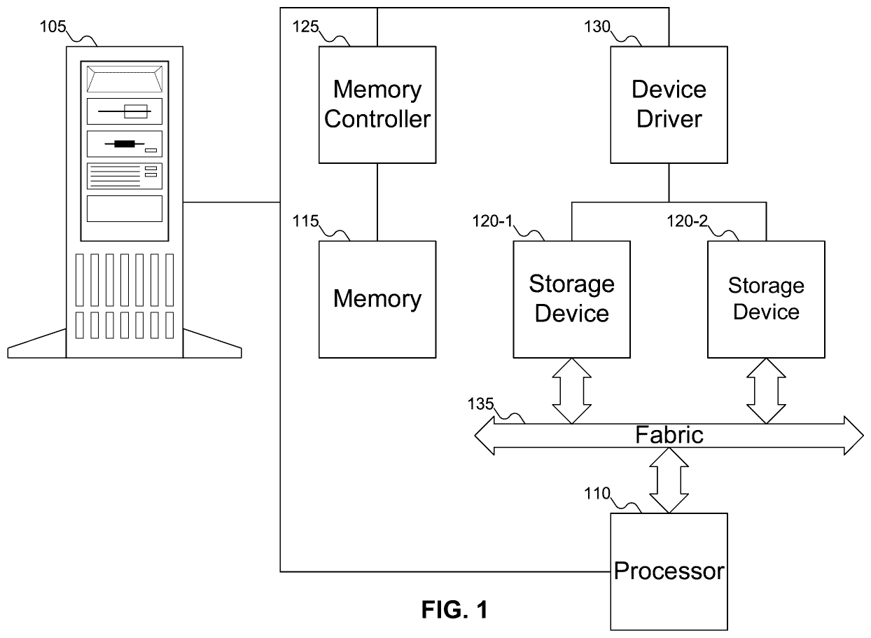

FIG. 1 shows a machine including a fabric supporting fabric-based computing, according to embodiments of the disclosure. In FIG. 1, machine 105, which may also be termed a host or a system, may include processor 110, memory 115, and storage devices 120-1 and 120-2 (which may be referred to collectively as storage devices 120).

Processor 110, which may also be referred to as a host processor, may be any variety of processor. (Processor 110, along with the other components discussed below, are shown outside the machine for case of illustration: embodiments of the disclosure may include these components within the machine.) While FIG. 1 shows a single processor 110, machine 105 may include any number (one or more, without bound) of processors, each of which may be single core or multi-core processors, each of which may implement a Reduced Instruction Set Computer (RISC) architecture or a Complex Instruction Set Computer (CISC) architecture (among other possibilities), and may be mixed in any desired combination.

Processor 110 may be coupled to memory 115. Memory 115, which may also be referred to as a main memory, may be any variety of memory, such as flash memory, Dynamic Random Access Memory (DRAM), Static Random Access Memory (SRAM), Persistent Random Access Memory, Ferroelectric Random Access Memory (FRAM), or Non-Volatile Random Access Memory (NVRAM), such as Magnetoresistive Random Access Memory (MRAM) etc. Memory 115 may also be any desired combination of different memory types, and may be managed by memory controller 125. Memory 115 may be used to store data that may be termed “short-term”: that is, data not expected to be stored for extended periods of time. Examples of short-term data may include temporary files, data being used locally by applications (which may have been copied from other storage locations), and the like.

Processor 110 and memory 115 may also support an operating system under which various applications may be running. These applications may issue requests (which may also be termed commands) to read data from or write data to either memory 115 or storage device 120-1 and 120-2. Whereas memory 115 may be used to store data that is considered “short-term”, storage devices 120 may be used to store data that is considered “long-term”: that is, data that is expected to be retained for longer periods of time and that should be retained in a persistent manner, even if delivery of power to machine 105 should be interrupted. Storage devices 120 may be accessed using device driver 130.

Storage device 120 may be associated with an accelerator. Such an accelerator may be used for, for example, near-data processing. That is, the accelerator may be used to process data closer to storage device 120, to reduce or eliminate transfer of data from storage device 120 into memory 115. The use of an accelerator for near-data processing may also offload processing from processor 110, as the accelerator may perform such processing instead of processor 110. Like processor 110, such an accelerator may implement a Reduced Instruction Set Computer (RISC) architecture or a Complex Instruction Set Computer (CISC) architecture (among other possibilities), and may be implemented using a Central Processing Unit (CPU), a Field

Programmable Gate Array (FPGA), an Application-Specific Integrated Circuit (ASIC), A System-on-a-Chip (SoC), a Graphics Processing Unit (GPU), a General Purpose GPU (GPGPU), a Neural Processing Unit (NPU), or a Tensor Processing Unit (TPU).

The combination of storage device 120 and accelerator may also be referred to as a computational storage device, computational storage unit, computational storage device, or computational device. Storage device 120 and an accelerator may be designed and manufactured as a single integrated unit, or the accelerator may be separate from storage device 120. The phrase “associated with” is intended to cover both a single integrated unit including both a storage device and an accelerator and a storage device that is paired with an accelerator but that are not manufactured as a single integrated unit. In other words, a storage device and an accelerator may be said to be “paired” when they are physically separate devices but are connected in a manner that enables them to communicate with each other. Further, in the remainder of this document, any reference to storage device 120 may be understood to refer to both storage device 120 and the accelerator either as physically separate but paired (and therefore may include the other device) or to both devices integrated into a single component as a computational storage unit.

In addition, the connection between the storage device and the paired accelerator might enable the two devices to communicate, but might not enable one (or both) devices to work with a different partner: that is, the storage device might not be able to communicate with another accelerator, and/or the accelerator might not be able to communicate with another storage device. For example, the storage device and the paired accelerator might be connected serially (in either order) to the fabric, enabling the accelerator to access information from the storage device in a manner another accelerator might not be able to achieve.

While FIG. 1 uses the generic term “storage device”, embodiments of the disclosure may include any storage device formats that may be associated with computational storage, examples of which may include hard disk drives and Solid State Drives (SSDs). Any reference to a specific type of storage device, such as an “SSD”, below should be understood to include such other embodiments of the disclosure.

Processor 110 and storage devices 120 (and an accelerator, if included in machine 105) are shown as connecting to fabric 135. Fabric 135 is intended to represent any fabric along which information may be passed. Fabric 135 may include fabrics that may be internal to machine 105, and which may use interfaces such as Peripheral Component Interconnect Express (PCIe), Serial AT Attachment (SATA), or Small Computer Systems Interface (SCSI), among others. Fabric 135 may also include fabrics that may be external to machine 105, and which may use interfaces such as Ethernet, Infiniband, or Fibre Channel, among others. In addition, fabric 135 may support one or more protocols, such as Non-Volatile Memory Express (NVMe), NVMe over Fabrics (NVMe-oF), Simple Service Discovery Protocol (SSDP), or a cache-coherent interconnect protocol, such as the Compute Express Link® (CXL®) protocol, among others. (Compute Express Link and CXL are registered trademarks of the Compute Express Link Consortium in the United States.) Thus, fabric 135 may be thought of as encompassing both internal and external networking connections, over which commands may be sent, either directly or indirectly, to storage devices 120. In embodiments of the disclosure where fabric 135 supports external networking connections, storage devices 120 (and/or an accelerator, if included) might be located external to machine 105. That is, processor 110 might be in a different host 105 than storage devices 120.

FIG. 1 shows processor 110 and storage devices 120 as being connected to fabric 135 because processor and storage devices 120 may communicate via fabric 135. In some embodiments of the disclosure, storage devices 120 may include a connection to fabric 120 that may include the ability to communicate with a remote machine and/or a network: for example, a network-capable Solid State Drive (SSD). But in other embodiments of the disclosure, while machine 105 may include a connection to another machine and/or a network (which connection may be considered part of fabric 135), storage devices 120 might not be connected to another machine and/or network. In such embodiments of the disclosure, storage devices 120 may still be reachable from a remote machine, but such commands may pass through processor 110, among other possibilities, to reach storage devices 120.

Storage device 120 is an example of a device with which processor 110 may communicate. But processor 110 might also communicate with other devices. For example, processor 110 might communicate with an accelerator or a network interface card across fabric 135, among other possibilities. Any reference to storage device 120 below may be understood as being a specific example of any such device, and any reference to device 120 below should be understood as including, among other possible devices, storage devices 120, an accelerator, a network interface card, a graphics card, a memory device, or any other device which might transfer data across fabric 135, whether or not explicitly discussed.

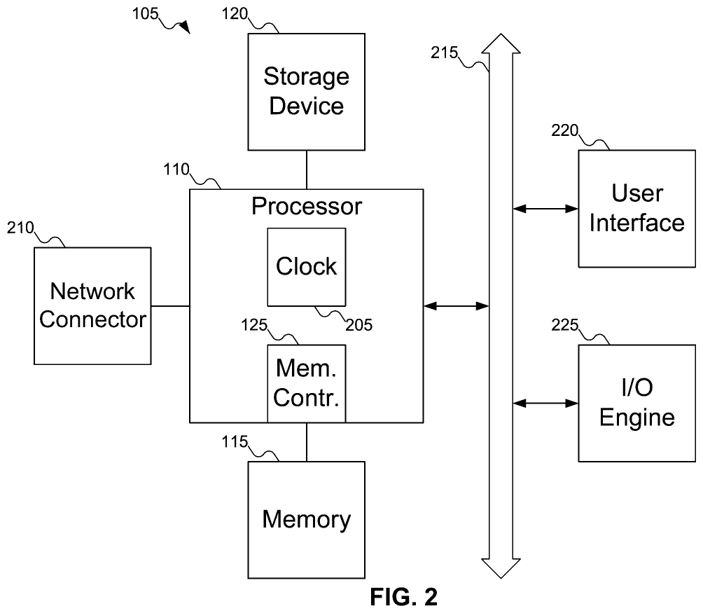

FIG. 2 shows details of the machine of FIG. 1, according to embodiments of the disclosure. In FIG. 2, typically, machine 105 includes one or more processors 110, which may include memory controllers 125 and clocks 205, which may be used to coordinate the operations of the components of the machine. Processors 110 may also be coupled to memories 115, which may include random access memory (RAM), read-only memory (ROM), or other state preserving media, as examples. Processors 110 may also be coupled to storage devices 120, and to network connector 210, which may be, for example, an Ethernet connector or a wireless connector. Processors 110 may also be connected to buses 215, to which may be attached user interfaces 220 and Input/Output (I/O) interface ports that may be managed using I/O engines 225, among other components.

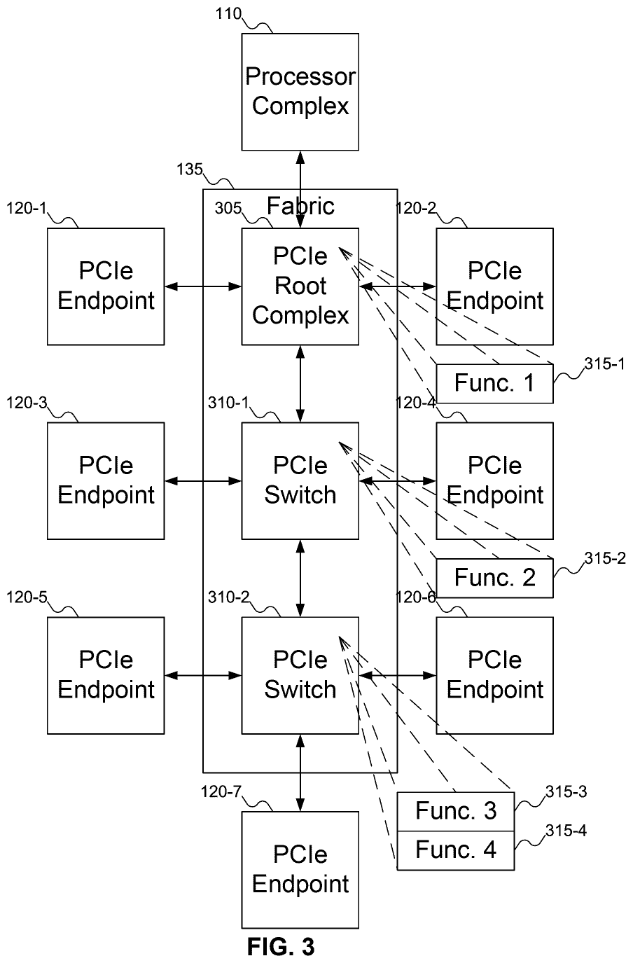

FIG. 3 shows an example architecture for fabric 135 of FIG. 1, according to embodiments of the disclosure. In FIG. 3, a PCIe fabric 135 is shown, but embodiments of the disclosure may include fabrics of other architectures. Processor complex 110 may be connected to PCIe root complex 305, which in turn may be connected to PCIe switch 310-1, which in turn may be connected to PCIe switch 310-2. (PCIe switches 310-1 and 310-2 may be referred to collectively as PCIe switches 310.) Each component in fabric 135-in FIG. 3, three such components: PCIe root complex 305 and PCIe switches 310-are shown, but embodiments of the disclosure may include any number (one or more) of components. In addition, embodiments of the disclosure may refer to the components of fabric 135 using terms other than root complex and switch, and embodiments of the disclosure may also include other types of components other than root complexes and switches.

Connected to the various fabric components 305 and 310 may be various devices, shown as PCIe endpoints 120-1 through 120-7, which may also be referred to as devices 120. Devices 120 may be any desired types of devices, including, for example, storage devices 120, network interface cards, graphic processors, etc. In addition, while FIG. 3 assigns a different reference number to processor complex 110 than to endpoints 120, from some perspectives processor complex 110 may also be considered a type of device 120. While FIG. 3 shows three fabric components 305 and 310 and seven PCIe endpoints 120, embodiments of the disclosure may include any number (one or more) of fabric components 305 and 310, and any number (two or more) of PCIe endpoints 120.

Fabric components 305 and 310 may implement various transformation functions. For example, in FIG. 3, root complex 305 is shown as including transformation function 315-1, switch 310-1 is shown as including transformation function 315-2, and switch 310-2 is shown as including transformation functions 315-3 and 315-4 (transformation functions 315-1, 315-2, 315-3, and 315-4 may be referred to collectively as transformation functions 315 or more simply as functions 315). Different fabric components 305 and 310 may each include any number (zero or more) transformation functions 315. In addition, cach transformation function 315 may be a unique transformation function, or transformation functions 315 may duplicate each other. For example, transformation functions 315-1 and 315-4 might be the same transformation function, implemented in different fabric components.

Transformation functions 315 may implement any desired functionality. Example functions that may be implemented as transformation functions 315 may include hash functions, filter functions, encryption/decryption functions, compression/decompression functions, statistical functions, such as count, standard deviation, variance, minimum, maximum, or average functions, or matrix multiplication functions. Transformation functions 315 may also include other functions not listed above.

The purpose of transformation functions 315 may be to transform the data, being sent from one device 120 to another device 120, to avoid having processor 110 execute such a transformation. Instead, the data may be transformed on route from a source device 120 to a destination device 120.

Fabric component 305 or 310 may implement transformation function 315 using any desired approach. Fabric component 305 or 310 may include a Central Processing Unit (CPU), a Field Programmable Gate Array (FPGA), an Application-Specific Integrated Circuit (ASIC), A System-on-a-Chip (SoC), a Graphics Processing Unit (GPU), a General Purpose GPU (GPGPU), a Neural Processing Unit (NPU), or a Tensor Processing Unit (TPU), among other possibilities, to implement transformation function 315.

Note that transforming the data may have implications other than just changing the data itself. For example, consider the use of a hash function as transformation function 315. The data input to a hash function may be of any data size from zero bytes (at the minimum) to any unbounded size. But the output of the hash function may be a fixed number of bits/bytes. For example, the SHA-256 function may return a hash value that is 32 bytes (256 bits) long, regardless of the size of the input data. This fact means that any information in the data that correlates, for example, to the length of the data or checksum/parity information may also be changed as a result of executing the transformation function on the data. For example, a Transaction Layer Packet (TLP) header may include information about the length of the data payload: if the size of the data payload has changed, then the length field in the TLP may also be changed to match. Similarly, the TLP may include a TLP digest, which may include a Cyclic Redundancy Check (CRC). If the data payload is changed, the CRC may also be changed to match the new data payload.

It might be asked whether the fact that the amount of data received at destination device 120 is different from the amount of device sent from source device 120 is a concern. But the fact that processor 110 requested transformation function 315 be executed means that processor 110 is aware that the amount of data to be received at destination device 120 may differ from the amount of data sent from source device 120. In the same way, destination device 120 may know how much data to expect, even if different in size from the data being sent from source device 120. Thus, it is possible that the data sent by source device 120 might be larger or smaller than the data received at destination device 120, as a result of transformation function 315.

In some embodiments of the disclosure, processor 110 may know what transformation functions 315 are offered by which fabric components 305 and 310. For example, during discovery of all attached devices, fabric components 305 and 310 may also be identified (which may also be described as enumeration). As part of discovery, fabric components 305 and 310 may include information about what transformation functions 315, if any, are offered by fabric components 305 and 310. For example, during discovery, root complex 305 may report that it offers function 315-1, switch 310-1 may report that it offers function 315-2, and switch 310-2 may report that it offers functions 315-3 and 315-4. This reporting may include more than just that fabric components 305 and 310 offer transformation functions 315: this reporting may also identify what transformation functions 315 do: for example, that transformation function 315-4 is a hash function (and what particular hash function), or that transformation function 315-2 is an encryption/decryption function (and what particular encryption/decryption function).

This discovery process may also include information about what devices are attached to each fabric component 305 and 310. Thus, for example, switch 310-2 may report that devices 120-5, 120-6, and 120-7 are attached to switch 310-2, switch 310-1 may report that devices 120-3 and 120-4 and switch 310-2 are attached to switch 310-1, and root complex 305 may report that devices 120-1 and 120-2 and switch 310-1 are attached to root complex 305. In this manner, processor 110 may be aware of the complete structure of fabric 135 and all devices attached thereto.

Knowing which devices 120 are attached to which fabric components 305 and 310 may be important. For example, in some embodiments of the disclosure, any data transformation may be performed only by fabric components 305 and 310 that are along the path between source device 120 and destination device 120. For example, consider the situation where processor 110 is requesting data to be read from device 120-7. In that situation, any transformation function 315 offered by root complex 305 and either of switches 310-1 and 310-2 is theoretically available for use to transform data. But if processor 110 is requesting that data be sent from, say device 120-1 to device 120-4, then the path between devices 120-1 and 120-4 may include only root complex 305 and switch 310-1. As transformation functions 315-3 and 315-4 are offered by switch 310-2 that is not on the path between devices 120-1 and 120-4, transformation functions 315-3 and 315-4 might not be available. But note that in other embodiments of the disclosure, data may be routed to leverage any function offered by any fabric component 305 and 310, even if such routing involves data travelling outside the ordinary path the data might take.

Because which transformation functions 315 are available might depend on source device 120 and destination device 120, not every transformation function 315 might be available for use on any data. Thus, processor 110 may need to know what fabric components 305 and 310 are along the path between source device 120 and destination device 120, to know what transformation functions 315 might be available. In some situations, it might happen that a particular transformation function 315 might not be usable, even though that transformation function 315 exists. In that case, processor 110 may need to have the data transferred first to processor 110 so that processor 110 may perform the transformation itself before the data is delivered to destination device 120. For example, consider again the situation where processor 110 wants to transfer data from source device 120-1 to destination device 120-4, but wants the data transformed before it is delivered to destination device 120-4. If the only transformation function 315 that might perform the transformation along the path is transformation function 315-3, which is not on the path between devices 120-1 and 120-4, processor 110 may instead need to request that the data be transferred from source device 120 to processor 110, where processor 110 may then perform the transformation itself. Processor 110 may then transfer the (now transformed) data to destination device 120-4.

In some embodiments of the disclosure, devices 120 might offer their own transformation functions. If devices 120 offer transformation functions 315, these transformation functions 315 may also be considered to be available, although such transformation functions 315 might not be considered part of fabric 135 (and might only be usable for data being sent from or to that particular device 120).

In some situations, multiple transformation functions 315 may be applied to data in sequence. For example, consider the situation where processor 110 requests that data be accessed from device 120-7 and delivered to processor 110. Processor 110 may also know that data stored on device 120-7 is stored encrypted, and therefore may require decryption. Then, after the data is decrypted, processor 110 may specify that the data be filtered, since only part of the data is relevant (for example the rows in a table in a database that satisfy a particular condition). Finally, since processor 110 is only interested in the number of rows in the table that satisfy the condition, processor 110 may specify a further transformation to count the number of rows in the table (a statistical function).

To accomplish all of this, processor 110 may request that switch 310-2 is to execute a decryption function 315 (processor 110 may provide the key to be used in decrypting the data for a decryption function 315 to execute). Processor 110 may also request that switch 310-1 is to execute a filtering function 315 (processor 110 may provide the condition to be used in filtering the data). Finally, processor 110 may request that root complex 305 is to execute a statistical count function to count the number of rows in the data. Thus, by the time processor 110 receives the data, the data has been decrypted, filtered, and counted, and processor 110 may receive the relevant information (the count of the number of rows in the table that satisfy the condition) without having to perform decryption, filtering, or counting of the data.

In some embodiments, cach fabric component 305 and 310 may be requested to perform one transformation on the data. In such embodiments of the disclosure, it may be important that cach fabric component 305 and 310 offer the transformation function 315 to be performed at that fabric component 305 and 310. Thus, in the above example, if switch 310-1 does not offer the filtering function, then root complex 305 would not be able to execute the count function on the filtered data (although if root complex 305 offered the filtering function, then processor 110 would only need to execute the count function on the data filtered by root complex 305). In other embodiments of the disclosure, fabric components 305 and 310 may be requested to perform multiple transformation functions 315 in sequence before sending on the data as fully transformed by that fabric component 305 and 310. Thus, in the above example, if switch 310-2 offers both the decryption function and the filtering function, processor 110 might request that switch 310-2 executes the decryption function followed by the filtering function, and root complex 305 (or switch 310-1) may execute the count function.

To request that a particular fabric component 305 or 310 is to execute a particular transformation function 315, processor 110 may include a TLP prefix (which may be thought of an extension of a TLP header, or alternatively that the TLP header is itself an extended TLP header based on the TLP prefix). A TLP prefix may be used to provide optional information or to modify a standard TLP header. TLP prefixes are typically 32 bits (4 bytes) in length: multiple TLP prefixes may be used to provide additional data. A TLP prefix may request, for example, that a particular fabric component 305 or 310 is to execute a particular transformation function 315 (for example, by identifying the fabric component 305 or 310 and/or the transformation function 315). If multiple such transformations are to be performed, for example, each such transformation may be requested in a single TLP prefix, or each may be requested in a separate TLP prefix.

In some situations, it might happen that a particular transformation function 315 whose execution was requested might not be executed. For example, if transformation function 315 expects the data in a particular format and that format is not provided, then transformation function 315 might fail. Or, for example, if transformation function 315 depends on available memory within fabric component 305 or 310 but that memory is not available or is insufficient to the data to be transformed, then transformation function 315 might fail. In such situations, fabric component 305 or 310 may return an error to processor 110 (or whatever device initiated the requested data transfer and requested transformation function 315), so that processor 110 may be aware that transformation function 315 did not execute as requested. For example, fabric component 305 or 310 might return an abort in a Completion Status field, or might return an Unsupported Request (UR) to indicate that the requested operation is not supported by fabric component 305 or 310.

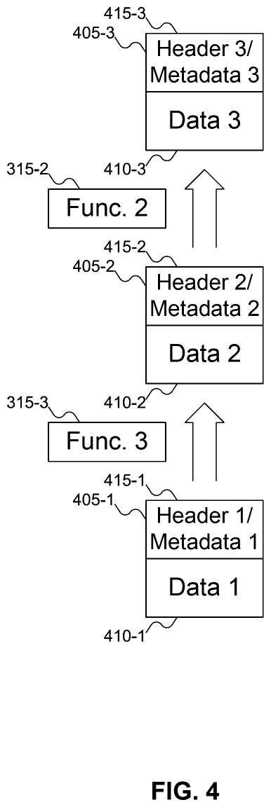

FIG. 4 shows an example of the transformations that may be performed by fabric 135. In FIG. 4 packets 405-1, 405-2, and 405-3 are shown. Packets 405-1, 405-2, and 405-3 may be referred to collectively as packets 405. Each packet 405 may include data and a header with metadata information. Thus, for example, packet 405-1 may include data 410-1 and header/metadata 415-1, packet 405-2 may include data 410-2 and header/metadata 415-2, and packet 405-3 may include data 410-3 and header/metadata 415-3. (Data 410-1, 410-2, and 410-3 may be referred to collectively as data 410, and header/metadata 415-1, 415-2, and 415-3 may be referred to collectively as header/metadata 415, header 415, or metadata 415, depending on the context.) In some embodiments of the disclosure, packets 405 may include additional sections, such as extended TLP headers, TLP prefixes, or a digest, which might include additional information relevant to or that transformation functions 315 might impact. Header/metadata 415 is intended to cover any and all such variations of organizing information that is relevant to the packet but is not data 410. For example, if packets 405 are TLPs, packets 405 may include a digest that may include parity information, such as a CRC.

It is worth noting that there is a difference between header information and metadata information in header/metadata 415. Header 415 may refer to information used in routing data 410, but may otherwise be unrelated to data 410: that is, header 415 may be the same regardless of data 410, so long as source device 120 of FIG. 1 and/or destination devices 120 of FIG. 1 are the same. On the other hand, metadata 415 may include information that depends on data 410, and therefore may vary depending on data 410. For example, the length of data 410, or parity information, such as CRC, may vary with data 410. But in general, metadata 415 may be stored in packets 405 separately from data 410, and thus might be included with headers 415.

In FIG. 4, transformation function 315-3 may operate on packet 410-1 to produce packet 410-2. For example, transformation function 315-3 might be the decryption function discussed above. Thus, data 410-1 might be encrypted data, whereas data 410-2 might be the decrypted data. Then, transformation function 315-2 may operate on packet 405-2 to produce packet 410-3. For example, transformation function 315-2 might be the filtering function discussed above. Thus, data 410-3 might be the (decrypted) data 410-2 subject to filtering.

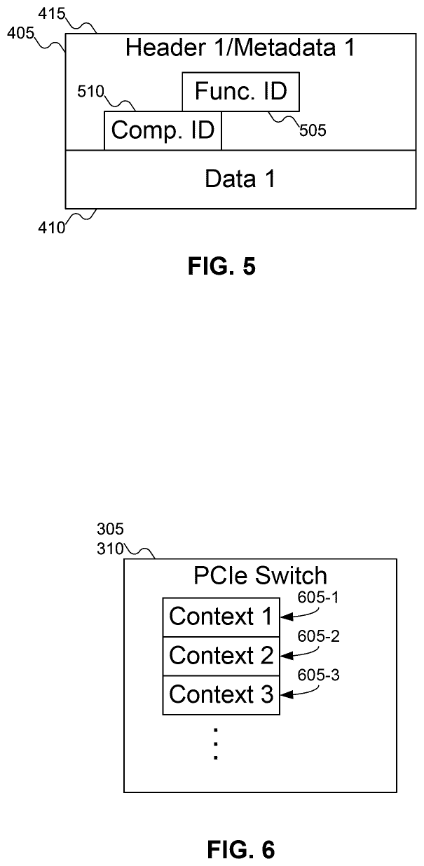

FIG. 5 shows how header 415 may include metadata 415. In FIG. 5, packet 405 is shown as including data 410 and header/metadata 415. Header/metadata 415 may include identifier 505 of transformation function 315 of FIG. 3, as well as identifier 510 of fabric component 305 or 310 of FIG. 3 (header/metadata 415 may also include other information not shown in FIG. 5). Identifier 505 may identify in some manner a particular transformation function 315 of FIG. 3 requested to be executed on data (which may include data 410). Identifier 510 may identify fabric component 305 or 310 that processor 110 of FIG. 1 requests perform transformation function 315 of FIG. 3 identified by identifier 505. In this manner, processor 110 of FIG. 1 may request a particular transformation function 315 be executed on certain data, as well as which fabric component 305 or 310 of FIG. 3 is to perform the requested transformation function 315 of FIG. 3.

Returning to FIG. 3, as discussed above, processor 110 may be aware of what functions 315 are offered by each fabric component 305 and 310. Thus, in some embodiments of the disclosure, processor 110 may request which fabric components 305 or 310 are to execute which transformation functions 315. That is, in the above example, processor 110 may specifically request that switch 310-2 execute the decryption function, that switch 310-1 execute the filtering function, and that root complex 305 execute the count function. Such assignments may be made as part of the request that the data be transferred from device 120-7. For example, in sending a Memory Read (MemRd) request TLP to device 120-7, the MemRd request TLP (or packet 405 of FIG. 4 that includes the MemRd request TLP) may request that switch 310-2 is to execute the decryption function (and may provide the applicable decryption key), that switch 310-1 is to execute the filtering function (and may provide the applicable condition), and that root complex 305 is to execute the count function. Other types of functions that might be used to request transformations might include Memory Write (MemWr) request TLPs, Peer-to-Peer (P2P) data transfers, and Direct Memory Access (DMA) functions; still other types of functions may also include transformation requests.

In other embodiments of the disclosure, processor 110 may request which transformation functions 315 are to be applied, but without specifying which fabric component 305 and 310 is to execute any particular transformation function 315. In such embodiments of the disclosure, cach fabric component 305 or 310 may decide for itself whether it will execute a particular transformation function 315. Whether fabric component 305 or 310 may opt to execute a particular transformation function may be determined based on, among other factors, whether fabric component 305 or 310 offers the transformation function 315 to be executed, how many transformation functions 315 have been requested during the fabric-based compute, and how close fabric component 305 or 310 is to source device 120. As an example of the latter factor, consider switch 310-2. Data flowing through switch 310-2 may either originate or be destined for only devices 120-5, 120-6, and 120-7: three devices. Data flowing through switch 310-2 may also originate or be destined for devices 120-3 and 120-4-five devices-and data flowing through root complex 305 may also originate or be destined for devices 120-1 and 120-2 or processor 110: eight devices. As the number of devices for which data may be flowing through fabric component 305 or 310 increases, the more transformation functions it might be expected to execute. By having fabric component 305 or 310 closest to source device 120 (or destination device 120) execute a transformation function 315, the lower the load on that fabric component 305 or 310 is likely to be. Again, for example, switch 310-2 is likely to only execute transformations for data originating at or destined for three devices 120, whereas switch 310-1 might execute transformations for data originating at or destined for five devices 120, and root complex 305 might execute transformations for data originating at or destined for eight devices 120. By having fabric component 305 or 310 with the fewest connected devices, the loads for executing transformation functions 315 may be better balanced.

In some situations, transformation function 315 may be executed only on the data in packet 405 of FIG. 4. That is, the entirety of the data to be transformed might fit in one packet 405 of FIG. 4. But in other situations, the data might span multiple packets 405 of FIG. 4. How transformation function 315 may operate in such situations may depend on transformation function 315. Some transformation functions 315 might expect to receive all data before applying transformation function 315. For example, a matrix multiplication function might expect to have all data for the two matrices to be multiplied before beginning the matrix multiplication operation. (Of course, some implementations might support partial calculations being performed before both matrices are fully received, if the way the data is stored enables such implementations.) Other transformation functions 315 might operate on the data as it becomes available in packets 405 of FIG. 4, generating interim results until a final result is generated. For example, a hash function or a statistical function might generate interim results as packets 405 of FIG. 4 are received, with the interim results being combined as appropriate, until all the data is received and the final results may be generated. Still other transformation functions 315 might operate on units of data that are independent of each other. For example, an encryption/decryption function or a compression/decompression function might operate on chunks of, for example, 4 kilobytes (KB) of data, where each 4 KB chunk may be encrypted/decrypted/compressed/decompressed independently of any other chunk. And since the end result may include delivering all data as processed by transformation function 315, as cach chunk is encrypted/decrypted/compressed/decompressed, that transformed chunk may be sent on to destination device 120 while the next chunk is being transformed.

It may be expected that transformation functions 315 of FIG. 3 may involve processing data 410 of FIG. 4 in some manner. This processing may require some local storage (to store data 410 of FIG. 4 during processing), as well as a state machine to track where data 410 of FIG. 4 currently stands in processing. FIG. 6 illustrates how fabric components 305 and 310 of FIG. 3 may manage such storage and state machine information.

FIG. 6 shows details of fabric components 305 and 310 of FIG. 3 (although fabric component 305 would be equally applicable), according to embodiments of the disclosure. Contexts 605-1, 605-2, and 605-3, which may be referred to collectively as contexts 605, may be used to store data and the state machine. Fabric components 305 or 310 may also have additional logic appropriate to implement transformation functions 315 of FIG. 3 using the state machines stored in contexts 605. To store contexts 605, fabric components 305 or 310 may include some storage, such as DRAM or SRAM.

As an example of how contexts 605 might be used, consider the example transformation functions 315 of FIG. 3 discussed above. For a matrix multiplication function, which might wait until all the data is available to perform the matrix multiplication, contexts 605 may be used to store the matrices as received from source storage device 120 of FIG. 1. For a hash function, which might generate interim results until all the data has been received and transformed, contexts 605 might be used to store the interim hash value for data already received and subject to transformation function 315 of FIG. 3. For an encryption/decryption/compression/decompression function, which may receive a chunk of data, transform it, and send the transformed data on to destination device 120 of FIG. 1, contexts 605 might be used to store any information relevant to the encryption/decryption/compression/decompression: for example, what algorithm is being used to perform encryption/decryption/compression/decompression, and/or a key used to perform encryption/decryption/compression/decompression.

Note that if fabric components 305 or 310 are requested to perform two transformation functions 315 on data received from source device 120 of FIG. 1 (for example, to decrypt encrypted data, then to perform a hash function on the decrypted data), such multi-step transformations may require separate contexts 605 for each transformation step. Thus, one context 605 might be used for the decryption function, and another context 605 might be used for the hash function.

The size of contexts 605 may depend on transformation functions 315 of FIG. 3. For example, a matrix multiplication function might require 1 megabyte (MB) of data per context 605, whereas a hash function might require only 4 KB of data per context. Since the amount of storage provided for contexts 605 may affect the cost of fabric components 305 or 310, there may be a balancing act between supporting a large number of contexts and minimizing the overall cost of fabric components 305 or 310. The size of the storage used for contexts 605 may be any desired size, and the number of contexts 605 may be any number (one or more), effectively bounded primarily by the cost to increase the storage for contexts 605.

As contexts 605 may be used to support executing transformation functions 315 of FIG. 3 in fabric components 305 or 310, contexts 605 in fabric components 305 or 310 might not be needed for transformations executed by other fabric components 305 and/or 310. That is, contexts 605 might be used only for transformation functions 315 of FIG. 3 executed by fabric component 310, and not by transformation functions 315 of FIG. 3 executed by other fabric components 305 and/or 310 (those other fabric components 305 and/or 310 may have their own contexts 605 to support execution of their transformation functions 315 of FIG. 3).

Given that the number of contexts 605 may be bounded (as the number of contexts 605 may be fixed in advance during manufacture of fabric components 305 or 310) and that each transformation function 315 of FIG. 3 may use a context 605 to transform a particular data, the question might arise whether the number of transformation functions 315 of FIG. 3 that may be executed at any moment in time might also be capped. The answer to that question is yes: if executing transformation function 315 of FIG. 3 uses a context 605, then the number of contexts 605 may act as an upper bound on the number of transformation functions 315 of FIG. 3 that may be requested for execution at any moment in time in fabric components 305 or 310.

But if the number of contexts 605 may limit the number of transformations that may occur at any moment in time, then a follow-up question arises: how are contexts 605 managed? The answer to this question is that there are various ways in which contexts 605 may be managed. One approach is for fabric components 305 or 310 to allocate context 605 to transformation function 315 of FIG. 3 when fabric components 305 or 310 knows that it is to execute transformation function 315 of FIG. 3 on some data. That is, fabric components 305 or 310 may allocate context 605 upon receiving the original request from processor 110 of FIG. 1 that involves data transfer to destination device 120 of FIG. 1. The advantage of this approach is that context 605 is ensured to be available when the data to be transformed using transformation function 315 of FIG. 3 arrives at fabric components 305 or 310. But this approach also means that contexts 605 might be reserved longer than necessary (since they would not be used before data to be transformed actually arrives at fabric components 305 or 310).

Another approach is for fabric components 305 or 310 to allocate context 605 to transformation function 315 of FIG. 3 when fabric components 305 or 310 begin to receive the data to be transformed using transformation function 315 of FIG. 3. That is, fabric components 305 or 310 may allocate context 605 upon receiving packet 405 of FIG. 4 that contains the data to be transformed by transformation function 315 of FIG. 3 (which may, for example, be a completion packet from source device 120 of FIG. 1). This approach minimizes the time during which contexts 605 are allocated, but at the cost that if a context is not currently available, fabric components 305 or 310 may have to store packets 405 of FIG. 4 until a context becomes available (or may have to request source device 120 of FIG. 1 to resend packets 405 of FIG. 4).

Note that allocation of contexts 605 might be a consequence of fabric components 305 or 310 executing transformation function 315 of FIG. 3 on the data, but is separate from the determination that fabric component 305 or 310 is to execute transformation function 315 of FIG. 3 on the data. As discussed above, processor 110 of FIG. 1 may be responsible for selecting fabric component 305 or 310 to execute transformation function 315 of FIG. 3 on some data, or fabric components 305 and 310 may self-select to execute transformation function 315 of FIG. 3 on the data because fabric components 305 or 310 include transformation function 315 of FIG. 3.

But when processor 110 of FIG. 1 selects fabric component 305 or 310 to execute transformation function 315 on the data, as the management of contexts 605 is relevant to fabric component 305 or 310 being assigned to execute transformation function 315 of FIG. 3, processor 110 of FIG. 1 may want to track how many contexts 605 in fabric component 305 or 310 have been allocated to transformation functions 315 of FIG. 3. Thus, as part of advertising what transformation functions 315 of FIG. 3 fabric components 305 or 310 include, fabric components 305 or 310 may also advertise the number of contexts 605 fabric components 305 or 310 include. In this manner, processor 110 of FIG. 1 may know how many transformation functions 315 of FIG. 3 are currently executing on fabric components 305 or 310, and therefore how many contexts 605 are currently allocated (and thus how many contexts 605 are currently available for additional transformations to be requested at fabric components 305 or 310). Having processor 110 of FIG. 1 request fabric component 305 or 310 to execute transformation function 315 of FIG. 3 on the data therefore would dovetail neatly with fabric components 305 or 310 allocating contexts 605 when fabric component 305 or 310 becomes aware that it is expected to execute transformation function 315 of FIG. 3 (rather than when the data arrives).

Another question that might arise is how it might occur that context 605 is needed to execute transformation function 315 of FIG. 3, but no context 605 is available for allocation. The answer to this question is to recognize that the question includes an implicit assumption: that processor 110 of FIG. 1 is the only processor 110 of FIG. 1 requesting transformations at fabric component 305 or 310. But if fabric 135 of FIG. 1 connects to multiple processors 110 of FIG. 1, then one processor 110 of FIG. 1 might not be aware of what another processor 110 of FIG. 1 is doing. In this situation, the two (or more) processors 110 of FIG. 1 might request more transformations be executed at fabric components 305 or 310 than fabric components 305 or 310 have contexts 605.

There are several ways to handle this situation. One approach is for fabric components 305 or 310 to divide contexts 605 evenly (or as evenly as possible) between or among all processors 110 of FIG. 1 that might request transformations at fabric components 305 or 310. That way, cach processor 110 of FIG. I may track the number of contexts 605 it is using based on the number assigned to that processor 110 of FIG. 1. Another approach is for fabric components 305 or 310 to support an administrative command that would return the number of contexts 605 currently available upon request by processor 110 of FIG. 1: for example, as part of a Vendor Defined Message (VDM). Yet another approach is for fabric components 305 or 310 to process all transformations requested in the order received, and if transformations have to wait until a context is available, then those transformations may wait.

It is also worth noting that the assignment of contexts 605 to processors 110 of FIG. 1 might change as processors 110 of FIG. 1 “appear” or “disappear”. That is, processors 110 of FIG. 1 might come online and go offline independently of each other. This situation is more likely to occur with processors 110 of FIG. 1 in different hosts 105 of FIG. 1 that are connected to fabric 135 of FIG. 1, but this situation might also occur with multiple processors 110 of FIG. 1 in a single host 105 of FIG. 1. As processors 110 of FIG. 1 come and go, the number of contexts 605 assigned to each processor 110 of FIG. 1 might change, and fabric components 305 or 310 may notify processors 110 of FIG. 1 (similarly to how processors 110 of FIG. 1 performed discovery to initially learn about fabric component 310) about changes in the number of contexts 605 assigned to each host.

In some embodiments of the disclosure, each fabric component 305 or 310 may be responsible for managing its own contexts 605. Moreover, in some embodiments of the disclosure, fabric components 305 or 310 may handle their own contexts 605 independently of other fabric components 305 or 310. Put another way, fabric components 305 or 310 may not share contexts 605 of the information managed within contexts 605. But in other embodiments of the disclosure, the information managed by contexts 605 may be shared between fabric components 305 or 310. For example, after fabric component 310 completes a transformation of the data using context 605, fabric component 310 may transmit the information in context 605 to the next fabric component 305 or 310 to receive the data (or to a later fabric component 305 or 310). Fabric component 310 might send the information in context 605 as a separate packet of data, or might attach the information in context 605 to the packet containing the data being transmitted. The later fabric component 305 or 310 may then use the information provided in establishing its own context 605.

As discussed above, messages, such as VDMs, may be used to inform processors 110 of FIG. 1 about changes in the allocation of contexts 605 to processors 110 of FIG. 1. VDMs may be used to inform processors 110 of FIG. 1 about how many contexts 605 are assigned to each processor 110 of FIG. 1. For example, fabric components 305 or 310 may send a Message Signaled Interrupt (MSI) or an extended MSI (MSI-X) to notify processors 110 of FIG. 1 that fabric components 305 or 310 have new information. Processors 110 of FIG. 1 may then send a VDM to request information about the reason for the interrupt, to which fabric components 305 or 310 may respond with an updated allocation of contexts 605 to processors 110 of FIG. 1.

As discussed above, in some situations, fabric component 310 might need to wait for all the data to arrive at fabric component 310 before executing transformation function 315 of FIG. 3. In addition, executing transformation function 315 of FIG. 3 may take some additional time. But fabric 135 of FIG. 1 might have definitions for when a timeout is considered to have occurred: that is, when a response is sufficiently untimely that the original request is considered lost. The time spent waiting for data, and/or the time spent executing transformation function 315 of FIG. 3, might add up to enough time that fabric 135 of FIG. 1 might consider the original request to have timed out, triggering processor 110 of FIG. 1 to resend the request.

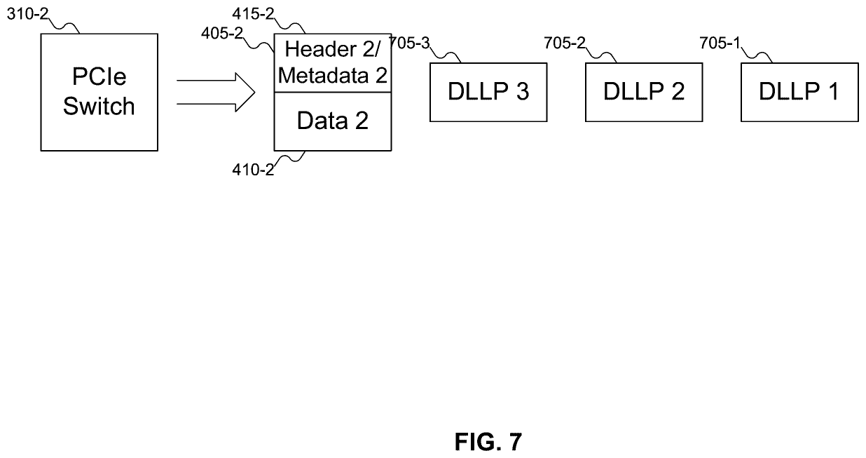

To avoid this situation, fabric component 310 may send packets 405 of FIG. 3 that prevent a timeout from occurring. This situation is reflected in FIG. 7.

In FIG. 7, fabric component 310 of FIG. 3 may keep a connection active while executing transformation function 315 of FIG. 3. To avoid a timeout, and to keep the connection with destination device 120 alive, fabric component 310 may send packets 705-1, 705-2, and 705-3 to keep the connection alive. Packets 705-1, 705-2, and 705-3, which may be referred to collectively as packets 705, might not contain any data, but might indicate to destination device 120 of FIG. 1 (and thus to fabric 135 of FIG. 1) that the response is still forthcoming.

In FIG. 7, packets 705 are shown as Data Link Layer Packets (DLLP) 705. The Data Link Layer is a layer below the transaction layer (which would generate TLPs). DLLPs may be sufficient to keep the connection alive and avoid a timeout, during which time fabric component 310 may generate packet 405 containing the transformed data.

Fabric component 310 may generate packets 705 at regular intervals sufficient to keep the connection alive. Note that tracking how long it has been since the last packet 705 has been sent might be managed by the state machine that is part of context 605 of FIG. 6. While FIG. 7 shows fabric component 310 sending three packets 705 before packet 405 is sent, embodiments of the disclosure may include sending any number (zero or more, without bound) packets 705 to keep a connection alive while the data is being transformed.

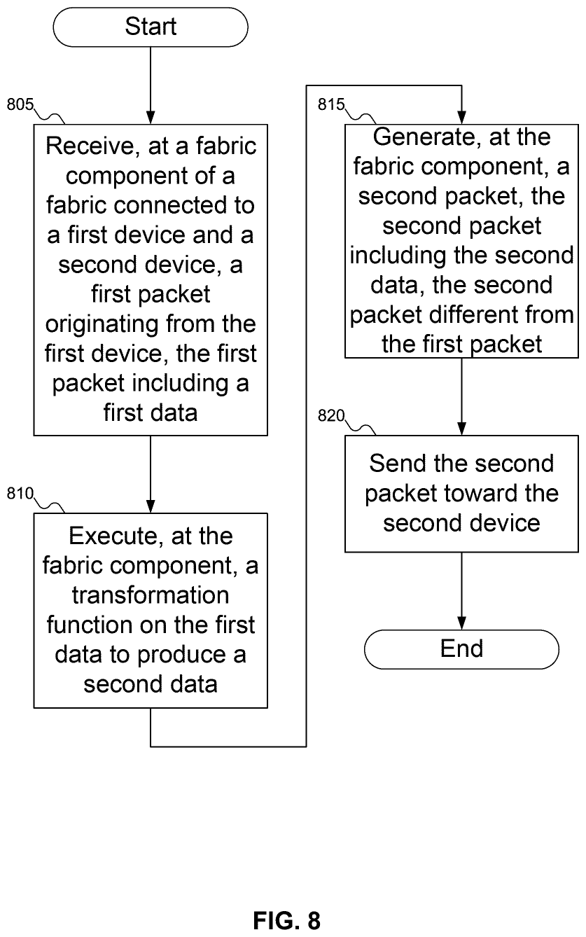

FIG. 8 shows a flowchart of an example procedure for fabric component 310 of FIG. 3 to execute transformation function 315 of FIG. 3 on packets 405 of FIG. 4, according to embodiments of the disclosure. In FIG. 8, at block 805, fabric component 305 or 310 of FIG. 3 may receive packet 405 of FIG. 4 from source device 120 of FIG. 1. Packet 405 of FIG. 4 may contain data 410 of FIG. 4. Note that packet 405 of FIG. 4 might not be received directly from source device 120 of FIG. 1, but might have originated at source device 120 and been received by fabric component 305 or 310 of FIG. 3 through some intervening element. For example, if device 120-7 of FIG. 3 sends packet 405 of FIG. 4 to processor 110 of FIG. 1, that packet 405 of FIG. 4 would be received eventually at fabric component 310-1 of FIG. 3, even though that packet 405 of FIG. 4 might first travel through fabric component 310-2 of FIG. 3.

At block 810, fabric component 305 or 310 of FIG. 3 may execute transformation function 315 of FIG. 3 on data 410 of FIG. 4 to produce a new data 410 of FIG. 4. At block 815, fabric component 305 or 310 of FIG. 3 may then generate a new packet 405 of FIG. 4 containing the new data 410 of FIG. 4. Because the data has been transformed and is therefore different on content, the new packet 405 of FIG. 4 may be different from the original packet 405 of FIG. 4.

Finally, at block 820, fabric component 305 or 310 of FIG. 3 may send the new packet 405 of FIG. 4 toward destination device 120 of FIG. 1. Note that fabric component 305 or 310 of FIG. 3 might not deliver the new packet 405 of FIG. 4 to destination device 120 of FIG. 1, but may send the new packet 405 of FIG. 4 in the direction of destination device 120 of FIG. 1, for delivery to be completed by some other fabric component 305 or 310 of FIG. 3. For example, if fabric component 310-1 of FIG. 3 sends the new packet 405 of FIG. 4 to processor 110 of FIG. 1, the new packet 405 of FIG. 4 would first be delivered to fabric component 305 of FIG. 3, before it is delivered to processor 110 of FIG. 1.

While FIG. 8 shows a one-time process, as discussed with reference to FIG. 3 above, embodiments of the disclosure may include multiple transformation steps. Thus, blocks 805-820 may be repeated at multiple fabric components 305 or 310 of FIG. 3. In addition, if one fabric component 305 or 310 of FIG. 3 performs multiple transformation steps, then block 810 may be repeated to execute cach transformation function 315 of FIG. 3 within that fabric component 305 or 310 of FIG. 3.

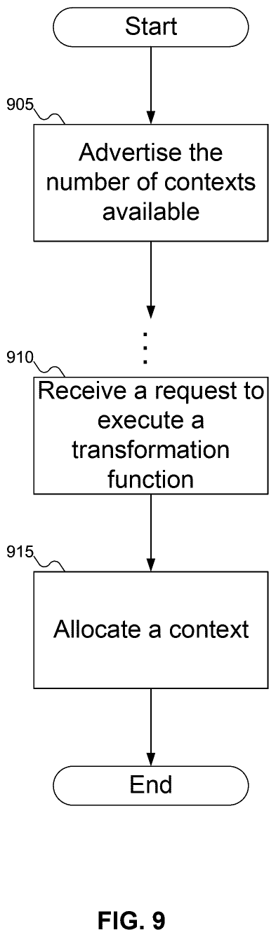

FIG. 9 shows a flowchart of an example procedure for fabric component 310 of FIG. 3 to advertise and use contexts 605 of FIG. 6, according to embodiments of the disclosure. In FIG. 9, at block 905, fabric component 305 or 310 of FIG. 3 may advertise a number of contexts 605 of FIG. 6 available at fabric component 305 or 310 of FIG. 3. At block 910, fabric component 305 or 310 of FIG. 3 may receive a request to execute transformation function 315 of FIG. 3 on some data 410 of FIG. 4. Note that this request may be received as part of a request for some data (that is, a packet 405 of FIG. 4 requesting the data), or as part of the data itself (that is, a packet 405 of FIG. 4 including the data). At block 915, fabric component 305 or 310 of FIG. 3 may allocate a context 605 of FIG. 6 to use in executing transformation function 315 of FIG. 3. As discussed with reference to FIG. 6 above, context 605 of FIG. 6 may be allocated when transformation function 315 of FIG. 3 is requested to be executed, or when data 410 of FIG. 4 to be transformed is received at fabric component 305 or 310 of FIG. 3.

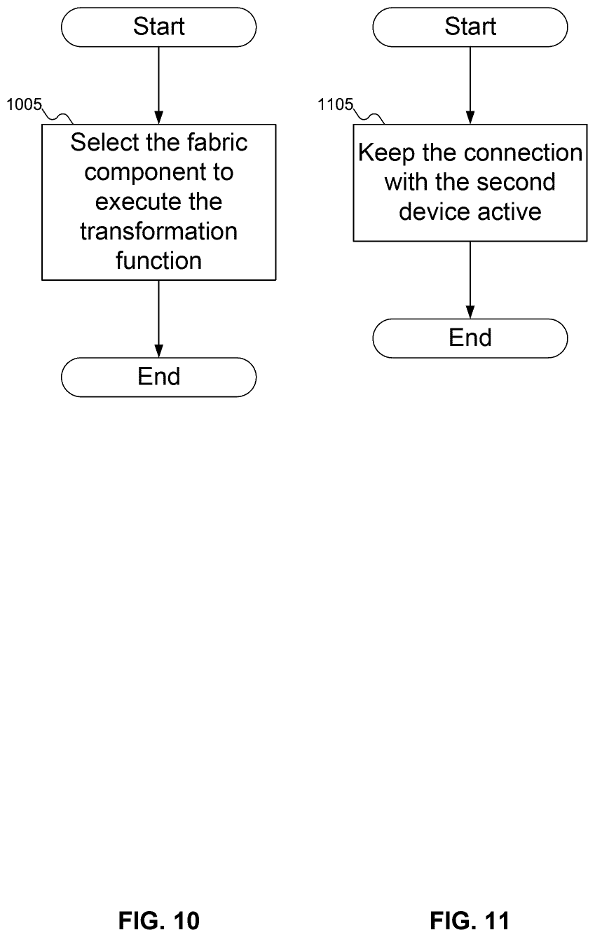

FIG. 10 shows a flowchart of an example procedure for fabric component 310 of FIG. 3 to select itself to execute transformation function 315 of FIG. 3 on packets 405 of FIG. 4, according to embodiments of the disclosure. In FIG. 10, at block 1005, fabric component 305 or 310 of FIG. 3 may determine that it supports transformation function 315 of FIG. 3 that has been requested to be applied to some data 410 of FIG. 4.

FIG. 11 shows a flowchart of an example procedure for fabric component 310 of FIG. 3 to keep a connection alive, according to embodiments of the disclosure. In FIG. 11, at block 1105, fabric component 305 or 310 of FIG. 3 may keep a connection with destination device 120 of FIG. 1 alive. For example, fabric component 305 or 310 of FIG. 3 may send DLLP packets 705 of FIG. 7 to prevent a timeout from occurring.

In FIGS. 8-11, some embodiments of the disclosure are shown. But a person skilled in the art will recognize that other embodiments of the disclosure are also possible, by changing the order of the blocks, by omitting blocks, or by including links not shown in the drawings. All such variations of the flowcharts are considered to be embodiments of the disclosure, whether expressly described or not.

Embodiments of the disclosure may include a compute capability within a fabric component. This compute capability may include a transformation function. The fabric component may apply the transformation function to data being delivered along the fabric, transforming the data en route. By including compute within components of the fabric, the processing load on the host processor may be reduced, thereby providing a technical advantage.

Computer architectures are advancing to address various bottlenecks exposed by standard designs.

Embodiments of the disclosure include evolving Peripheral Component Interconnect Express (PCIe) and/or Compute Express Link® (CXL®) to include computational features.

PCIe Root Complexes (RCs)/Switches/etc. are imbedded data transformations at the Transaction Layer Packet (TLP) level. The TLP may incorporate additional fields to indicate data transformation to perform inline. A new TLP may be generated in place of the old with transformed data (Length, Cyclic Redundancy Checks (CRCs), etc.). Such information may be relevant to both Memory Read (MemRd) and Memory Write (MemWr) TLPs that may include peer-to-peer (P2P) data movement.

PCIe RCs/Switches may use a context for multi-TLP transformations. The context may identify an internal engine that may maintain state for the flow. Once the flow is complete, the context may be freed for other use in another flow. This approach may be managed by the host or by the RC/switch itself. Host management may be simpler and may involve the host waiting until a context is free before initiating data movement.

The PCIe RC/switch may advertise the number of contexts available.

Traditional PCIe traffic is unaffected and flows per the spec.

Embodiments of the disclosure may focus on embedding compute capabilities that act on transaction flows within a PCIe entity to process data. Goals may include minimizing data movement (particularly in the host); allowing PCIe intermediary devices to process data via transformations; and adherence to the PCIe protocol to avoid completion timeouts or errors.

As an example flow, a host may request 4 KB of data from an endpoint device and may select the SHA-256 hash function, the Switch in the path to perform the hash function, and the context. A MemRd TLP may be issued to the endpoint device, which may be intercepted by the named Switch (given a transformation is to occur) and a context allocated. The MemRd may then be forwarded to the endpoint. Read completions sent by the device may be consumed by the switch with the SHA-256 hash performed on data in the Completion TLP. On the last Completion TLP, the SHA-256 hash is completed and the completion may flow to the host with the hash value. The context may then be freed.

In this example, the host should expect that instead of 4 KB of data resulting, only 32 bytes (256 bits) are actually transferred to the host (the SHA-256 hash).

Data Link Layer Packets (DLLPs) may be interspersed to avoid timeouts, potentially zero-sized MemRd completions.

The following discussion is intended to provide a brief, general description of a suitable machine or machines in which certain aspects of the disclosure may be implemented. The machine or machines may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines may include embedded controllers, such as programmable or non-programmable logic devices or arrays, Application Specific Integrated Circuits (ASICs), embedded computers, smart cards, and the like. The machine or machines may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciate that network communication may utilize various wired and/or wireless short range or long range carriers and protocols, including radio frequency (RF), satellite, microwave, Institute of Electrical and Electronics Engineers (IEEE) 802.11, Bluetooth®, optical, infrared, cable, laser, etc.

Embodiments of the present disclosure may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Embodiments of the disclosure may include a tangible, non-transitory machine-readable medium comprising instructions executable by one or more processors, the instructions comprising instructions to perform the elements of the disclosures as described herein.

The various operations of methods described above may be performed by any suitable means capable of performing the operations, such as various hardware and/or software component(s), circuits, and/or module(s). The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or steps of a method or algorithm and functions described in connection with the embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Having described and illustrated the principles of the disclosure with reference to illustrated embodiments, it will be recognized that the illustrated embodiments may be modified in arrangement and detail without departing from such principles, and may be combined in any desired manner. And, although the foregoing discussion has focused on particular embodiments, other configurations are contemplated. In particular, even though expressions such as “according to an embodiment of the disclosure” or the like are used herein, these phrases are meant to generally reference embodiment possibilities, and are not intended to limit the disclosure to particular embodiment configurations. As used herein, these terms may reference the same or different embodiments that are combinable into other embodiments.

The foregoing illustrative embodiments are not to be construed as limiting the disclosure thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this disclosure as defined in the claim.

Embodiments of the disclosure may extend to the following statements, without limitation:

Statement 1. An embodiment of the disclosure includes a system, comprising:
a first device;
a second device; and
a fabric connected to the first device and the second device, the fabric including a fabric component, the fabric component including a transformation function;
wherein the fabric component is configured to receive a first packet originating from the first device, the first packet including a first data, to execute the transformation function on the first data to generate a second data, and to send a second packet toward the second device, the second packet including the second data, wherein the second packet is different from the first packet.

Statement 2. An embodiment of the disclosure includes the system according to statement 1, wherein:
the first device includes a storage device; and
the second device includes a processor or a memory.

Statement 3. An embodiment of the disclosure includes the system according to statement 1, wherein the fabric component includes a root complex or a switch.

Statement 4. An embodiment of the disclosure includes the system according to statement 1, wherein the fabric includes a Peripheral Component Interconnect Express (PCIe) fabric or a Compute Express Link (CXL) fabric.

Statement 5. An embodiment of the disclosure includes the system according to statement 1, wherein:
the first packet includes a first Memory Read (MemRd) packet, a first Memory Write (MemWr) packet, a first Peer-to-Peer (P2P) packet, or a first Direct Memory Access (DMA) packet; and
the second packet includes a second MemRd packet, a second MemWr packet, a second P2P packet, or a second DMA packet.

Statement 6. An embodiment of the disclosure includes the system according to statement 1, wherein:
the first packet includes a first completion packet; and
the second packet includes a second completion packet.

Statement 7. An embodiment of the disclosure includes the system according to statement 1, wherein the transformation function includes a hash function, a filter function, an encryption function, a decryption function, a compression function, a decompression function, a statistical function, or a matrix multiplication function.

Statement 8. An embodiment of the disclosure includes the system according to statement 7, wherein the statistical function is one of a minimum function, a maximum function, or an average function.

Statement 9. An embodiment of the disclosure includes the system according to statement 1, wherein the fabric component is configured to generate an interim data using the transformation from the first data and to generate the second data using the transformation function on the interim data and a third data in a third packet originating from the first device received at the fabric component.

Statement 10. An embodiment of the disclosure includes the system according to statement 1, wherein the fabric further includes a second fabric component.

Statement 11. An embodiment of the disclosure includes the system according to statement 10, wherein a path along the fabric between the first device and the second device does not include the second fabric component.

Statement 12. An embodiment of the disclosure includes the system according to statement 10, wherein a path along the fabric between the first device and the second device includes the second fabric component.

Statement 13. An embodiment of the disclosure includes the system according to statement 10, wherein:
the second fabric component includes a second transformation function; and
the second fabric component is configured to receive the second packet from the fabric component, to execute the second transformation function on the second data to generate a third data, and to send a third packet toward the second device, the third packet including the third data, wherein the third packet is different from the first packet, and the second packet.

Statement 14. An embodiment of the disclosure includes the system according to statement 1, wherein the fabric component includes a context to manage execution of the transformation function.

Statement 15. An embodiment of the disclosure includes the system according to statement 14, wherein the fabric component is configured to advertise a number of contexts available at the fabric component.

Statement 16. An embodiment of the disclosure includes the system according to statement 14, wherein the fabric component is configured to allocate a context for execution of the transformation function based on receiving the first packet at the fabric component.

Statement 17. An embodiment of the disclosure includes the system according to statement 14, wherein the fabric component is configured to allocate a context for execution of the transformation function based on receiving a third packet from the second device, wherein the first packet is based at least in part on the third packet.

Statement 18. An embodiment of the disclosure includes the system according to statement 1, wherein the first device or the second device is configured to request the fabric component to execute the transformation function on the first data.

Statement 19. An embodiment of the disclosure includes the system according to statement 1, wherein:
the first device or the second device is configured to request execution of the transformation function on the first data; and
the fabric component is configured to select itself to execute the transformation function on the first data.

Statement 20. An embodiment of the disclosure includes the system according to statement 1, wherein the first packet includes an identifier of the transformation function.

Statement 21. An embodiment of the disclosure includes the system according to statement 20, wherein the first packet further includes a second identifier of the fabric component.

Statement 22. An embodiment of the disclosure includes the system according to statement 1, wherein the fabric component is configured to keep a connection to the second device active while executing the transformation function on the first data.

Statement 23. An embodiment of the disclosure includes the system according to statement 22, wherein the fabric component is further configured issue Data Link Layer Packets (DLLPs) to the second device to keep the connection to the second device active.

Statement 24. An embodiment of the disclosure includes the system according to statement 23, wherein the first packet includes a first Transaction Layer Packet (TLP) and the second packet includes a second TLP.

Statement 25. An embodiment of the disclosure includes the system according to statement 1, wherein:
the first packet further includes a first metadata associated with the first data;
the second packet further includes a second metadata associated with the second data; and
the second metadata is different from the first metadata.

Statement 26. An embodiment of the disclosure includes the system according to statement 25, wherein:
the first metadata includes a first length or a first parity information; and the second metadata includes a second length or a second parity information.

Statement 27. An embodiment of the disclosure includes a method, comprising:
receiving, at a fabric component of a fabric connected to a first device and a second device, a first packet originating from the first device, the first packet including a first data;
executing, at the fabric component, a transformation function on the first data to produce a second data;
generating, at the fabric component, a second packet, the second packet including the second data, the second packet different from the first packet; and
sending the second packet toward the second device.

Statement 28. An embodiment of the disclosure includes the method according to statement 27, wherein:
the first device includes a storage device; and
the second device includes a processor or a memory.

Statement 29. An embodiment of the disclosure includes the method according to statement 27, wherein the fabric component includes a root complex or a switch.

Statement 30. An embodiment of the disclosure includes the method according to statement 27, wherein the fabric includes a Peripheral Component Interconnect Express (PCIe) fabric or a Compute Express Link (CXL) fabric.

Statement 31. An embodiment of the disclosure includes the method according to statement 27, wherein:
the first packet includes a first Memory Read (MemRd) packet, a first Memory Write (MemWr) packet, a first Peer-to-Peer (P2P) packet, or a first Direct Memory Access (DMA) packet; and
the second packet includes a second MemRd packet, a second MemWr packet, a second P2P packet, or a second DMA packet.

Statement 32. An embodiment of the disclosure includes the method according to statement 27, wherein:
the first packet includes a first completion packet; and
the second packet includes a second completion packet.

Statement 33. An embodiment of the disclosure includes the method according to statement 27, wherein the transformation function includes a hash function, a filter function, an encryption function, a decryption function, a compression function, a decompression function, a statistical function, or a matrix multiplication function.

Statement 34. An embodiment of the disclosure includes the method according to statement 33, wherein the statistical function is one of a minimum function, a maximum function, or an average function.

Statement 35. An embodiment of the disclosure includes the method according to statement 27, wherein:
the method further comprises receiving, at the fabric component, a third packet originating from the first device, the third packet including a third data; and
executing, at the fabric component, the transformation function on the first data to produce the second data includes:
executing, at the fabric component, the transformation function on the first data to produce an interim data; and
executing, at the fabric component, the transformation function on the interim data and the third data to produce the second data.

Statement 36. An embodiment of the disclosure includes the method according to statement 27, wherein the fabric further includes a second fabric component.

Statement 37. An embodiment of the disclosure includes the method according to statement 36, wherein a path along the fabric between the first device and the second device does not include the second fabric component.

Statement 38. An embodiment of the disclosure includes the method according to statement 36, wherein a path along the fabric between the first device and the second device includes the second fabric component.

Statement 39. An embodiment of the disclosure includes the method according to statement 36, wherein sending the second packet toward the second device includes:
receiving, at the second fabric component, the second packet sent from the fabric component;
executing, at the second fabric component, a second transformation function on the second data to produce a third data;
generating, at the second fabric component, a third packet, the third packet including the third data, the third packet different from the first packet and the second packet; and
sending the third packet toward the second device.

Statement 40. An embodiment of the disclosure includes the method according to statement 27, further comprising allocating, at the fabric component, a context to manage execution of the transformation function.

Statement 41. An embodiment of the disclosure includes the method according to statement 40, further comprising advertising, by the fabric component, a number of contexts available at the fabric component.

Statement 42. An embodiment of the disclosure includes the method according to statement 40, wherein allocating, at the fabric component, the context to manage execution of the transformation function includes allocating, at the fabric component, the context to manage execution of the transformation function based on receiving the first packet at the fabric component.

Statement 43. An embodiment of the disclosure includes the method according to statement 40, wherein allocating, at the fabric component, the context to manage execution of the transformation function includes allocating, at the fabric component, the context to manage execution of the transformation function based on receiving a third packet from the second device, wherein the first packet is based at least in part on the third packet.

Statement 44. An embodiment of the disclosure includes the method according to statement 27, further comprising receiving, at the fabric component, a request from the second device for the fabric component to execute the transformation function on the first data.

Statement 45. An embodiment of the disclosure includes the method according to statement 44, wherein receiving, at the fabric component, the first packet includes receiving, at the fabric component, the request from the second device for the fabric component to execute the transformation function on the first data.

Statement 46. An embodiment of the disclosure includes the method according to statement 45, wherein the first packet includes the request from the second device for the fabric component to execute the transformation function on the first data.

Statement 47. An embodiment of the disclosure includes the method according to statement 44, wherein receiving, at the fabric component, a request from the second device for the fabric component to execute the transformation function on the first data includes receiving, at the fabric component, a third packet originating from the second device, the third packet including the request for the fabric component to execute the transformation function on the first data.

Statement 48. An embodiment of the disclosure includes the method according to statement 27, wherein executing, at the fabric component, the transformation function on the first data to produce a second data includes selecting the fabric component, by the fabric component, to execute the transformation function on the first data.

Statement 49. An embodiment of the disclosure includes the method according to statement 27, wherein the first packet includes an identifier of the transformation function.

Statement 50. An embodiment of the disclosure includes the method according to statement 49, wherein the first packet further includes a second identifier of the fabric component.

Statement 51. An embodiment of the disclosure includes the method according to statement 27, further comprising keeping, by the fabric component, a connection to the second device active while executing the transformation function on the first data.

Statement 52. An embodiment of the disclosure includes the method according to statement 51, wherein keeping, by the fabric component, a connection to the second device active while executing the transformation function on the first data includes sending Data Link Layer Packets (DLLPs) to the second device to keep the connection to the second device active.

Statement 53. An embodiment of the disclosure includes the method according to statement 52, wherein the first packet includes a first Transaction Layer Packet (TLP) and the second packet includes a second TLP.

Statement 54. An embodiment of the disclosure includes the method according to statement 27, wherein:
the first packet further includes a first metadata associated with the first data; and
generating, at the fabric component, the second packet, includes generating, at the fabric component, the second packet, the second packet including the second data and a second metadata associated with the second data, the second metadata different from the first metadata.

Statement 55. An embodiment of the disclosure includes the method according to statement 54, wherein:
the first metadata includes a first length or a first parity information; and
the second metadata includes a second length or a second parity information.

Statement 56. An embodiment of the disclosure includes a system, comprising a non-transitory storage medium, the non-transitory storage medium having stored thereon instructions that, when executed by a machine, result in:
receiving, at a fabric component of a fabric connected to a first device and a second device, a first packet originating from the first device, the first packet including a first data;
executing, at the fabric component, a transformation function on the first data to produce a second data;
generating, at the fabric component, a second packet, the second packet including the second data, the second packet different from the first packet; and
sending the second packet toward the second device.

Statement 57. An embodiment of the disclosure includes the system according to statement 56, wherein:
the first device includes a storage device; and
the second device includes a processor or a memory.

Statement 58. An embodiment of the disclosure includes the system according to statement 56, wherein the fabric component includes a root complex or a switch.

Statement 59. An embodiment of the disclosure includes the system according to statement 56, wherein the fabric includes a Peripheral Component Interconnect Express (PCIe) fabric or a Compute Express Link (CXL) fabric.

Statement 60. An embodiment of the disclosure includes the system according to statement 56, wherein:
the first packet includes a first Memory Read (MemRd) packet, a first Memory Write (MemWr) packet, a first Peer-to-Peer (P2P) packet, or a first Direct Memory Access (DMA) packet; and
the second packet includes a second MemRd packet, a second MemWr packet, a second P2P packet, or a second DMA packet.

Statement 61. An embodiment of the disclosure includes the system according to statement 56, wherein:
the first packet includes a first completion packet; and
the second packet includes a second completion packet.

Statement 62. An embodiment of the disclosure includes the system according to statement 56, wherein the transformation function includes a hash function, a filter function, an encryption function, a decryption function, a compression function, a decompression function, a statistical function, or a matrix multiplication function.

Statement 63. An embodiment of the disclosure includes the system according to statement 62, wherein the statistical function is one of a minimum function, a maximum function, or an average function.

Statement 64. An embodiment of the disclosure includes the system according to statement 56, wherein:
the non-transitory storage medium has stored thereon further instructions that, when executed by the machine, result in receiving, at the fabric component, a third packet originating from the first device, the third packet including a third data; and
executing, at the fabric component, the transformation function on the first data to produce the second data includes:
executing, at the fabric component, the transformation function on the first data to produce an interim data; and
executing, at the fabric component, the transformation function on the interim data and the third data to produce the second data.

Statement 65. An embodiment of the disclosure includes the system according to statement 56, wherein the fabric further includes a second fabric component.

Statement 66. An embodiment of the disclosure includes the system according to statement 65, wherein a path along the fabric between the first device and the second device does not include the second fabric component.

Statement 67. An embodiment of the disclosure includes the system according to statement 65, wherein a path along the fabric between the first device and the second device includes the second fabric component.

Statement 68. An embodiment of the disclosure includes the system according to statement 65, wherein sending the second packet toward the second device includes:
receiving, at the second fabric component, the second packet sent from the fabric component;
executing, at the second fabric component, a second transformation function on the second data to produce a third data;
generating, at the second fabric component, a third packet, the third packet including the third data, the third packet different from the first packet and the second packet; and sending the third packet toward the second device.

Statement 69. An embodiment of the disclosure includes the system according to statement 56, the non-transitory storage medium having stored thereon further instructions that, when executed by the machine, result in allocating, at the fabric component, a context to manage execution of the transformation function.

Statement 70. An embodiment of the disclosure includes the system according to statement 69, the non-transitory storage medium having stored thereon further instructions that, when executed by the machine, result in advertising, by the fabric component, a number of contexts available at the fabric component.

Statement 71. An embodiment of the disclosure includes the system according to statement 69, wherein allocating, at the fabric component, the context to manage execution of the transformation function includes allocating, at the fabric component, the context to manage execution of the transformation function based on receiving the first packet at the fabric component.

Statement 72. An embodiment of the disclosure includes the system according to statement 69, wherein allocating, at the fabric component, the context to manage execution of the transformation function includes allocating, at the fabric component, the context to manage execution of the transformation function based on receiving a third packet from the second device, wherein the first packet is based at least in part on the third packet.

Statement 73. An embodiment of the disclosure includes the system according to statement 56, the non-transitory storage medium having stored thereon further instructions that, when executed by the machine, result in receiving, at the fabric component, a request from the second device for the fabric component to execute the transformation function on the first data.

Statement 74. An embodiment of the disclosure includes the system according to statement 73, wherein receiving, at the fabric component, the first packet includes receiving, at the fabric component, the request from the second device for the fabric component to execute the transformation function on the first data.

Statement 75. An embodiment of the disclosure includes the system according to statement 74, wherein the first packet includes the request from the second device for the fabric component to execute the transformation function on the first data.

Statement 76. An embodiment of the disclosure includes the system according to statement 73, wherein receiving, at the fabric component, a request from the second device for the fabric component to execute the transformation function on the first data includes receiving, at the fabric component, a third packet originating from the second device, the third packet including the request for the fabric component to execute the transformation function on the first data.

Statement 77. An embodiment of the disclosure includes the system according to statement 56, wherein executing, at the fabric component, the transformation function on the first data to produce a second data includes selecting the fabric component, by the fabric component, to execute the transformation function on the first data.

Statement 78. An embodiment of the disclosure includes the system according to statement 56, wherein the first packet includes an identifier of the transformation function.

Statement 79. An embodiment of the disclosure includes the system according to statement 78, wherein the first packet further includes a second identifier of the fabric component.

Statement 80. An embodiment of the disclosure includes the system according to statement 56, the non-transitory storage medium having stored thereon further instructions that, when executed by the machine, result in keeping, by the fabric component, a connection to the second device active while executing the transformation function on the first data.

Statement 81. An embodiment of the disclosure includes the system according to statement 80, wherein keeping, by the fabric component, a connection to the second device active while executing the transformation function on the first data includes sending Data Link Layer Packets (DLLPs) to the second device to keep the connection to the second device active.

Statement 82. An embodiment of the disclosure includes the system according to statement 81, wherein the first packet includes a first Transaction Layer Packet (TLP) and the second packet includes a second TLP.

Statement 83. An embodiment of the disclosure includes the system according to statement 56, wherein:
the first packet further includes a first metadata associated with the first data; and
generating, at the fabric component, the second packet, includes generating, at the fabric component, the second packet, the second packet including the second data and a second metadata associated with the second data, the second metadata different from the first metadata.

Statement 84. An embodiment of the disclosure includes the system according to statement 83, wherein:
the first metadata includes a first length or a first parity information; and
the second metadata includes a second length or a second parity information.

Consequently, in view of the wide variety of permutations to the embodiments described herein, this detailed description and accompanying material is intended to be illustrative only, and should not be taken as limiting the scope of the disclosure. What is claimed as the disclosure, therefore, is all such modifications as may come within the scope and spirit of the following claims and equivalents thereto.

What is claimed is:

1. A system, comprising:
a first device;
a second device; and
a fabric connected to the first device and the second device, the fabric including a fabric component, the fabric component including a transformation function;
wherein the fabric component is configured to receive a first packet originating from the first device, the first packet including a first data, to execute the transformation function on the first data to generate a second data, and to send a second packet toward the second device, the second packet including the second data, wherein the second packet is different from the first packet.

2. The system according to claim 1, wherein the fabric further includes a second fabric component.

3. The system according to claim 2, wherein:
the second fabric component includes a second transformation function; and
the second fabric component is configured to receive the second packet from the fabric component, to execute the second transformation function on the second data to generate a third data, and to send a third packet toward the second device, the third packet including the third data, wherein the third packet is different from the first packet, and the second packet.

4. The system according to claim 1, wherein the fabric component includes a context to manage execution of the transformation function.

5. The system according to claim 1, wherein the first device or the second device is configured to request the fabric component to execute the transformation function on the first data.

6. The system according to claim 1, wherein:
the first device or the second device is configured to request execution of the transformation function on the first data; and
the fabric component is configured to select itself to execute the transformation function on the first data.

7. The system according to claim 1, wherein the first packet includes an identifier of the transformation function.

8. The system according to claim 1, wherein the fabric component is configured to keep a connection to the second device active while executing the transformation function on the first data.

9. The system according to claim 1, wherein:
the first packet further includes a first metadata associated with the first data;
the second packet further includes a second metadata associated with the second data; and
the second metadata is different from the first metadata.

10. A method, comprising:
receiving, at a fabric component of a fabric connected to a first device and a second device, a first packet originating from the first device, the first packet including a first data;
executing, at the fabric component, a transformation function on the first data to produce a second data;
generating, at the fabric component, a second packet, the second packet including the second data, the second packet different from the first packet; and
sending the second packet toward the second device.

11. The method according to claim 10, wherein:
the method further comprises receiving, at the fabric component, a third packet originating from the first device, the third packet including a third data; and
executing, at the fabric component, the transformation function on the first data to produce the second data includes:
executing, at the fabric component, the transformation function on the first data to produce an interim data; and
executing, at the fabric component, the transformation function on the interim data and the third data to produce the second data.

12. The method according to claim 10, wherein the fabric further includes a second fabric component.

13. The method according to claim 12, wherein sending the second packet toward the second device includes:
receiving, at the second fabric component, the second packet sent from the fabric component;
executing, at the second fabric component, a second transformation function on the second data to produce a third data;
generating, at the second fabric component, a third packet, the third packet including the third data, the third packet different from the first packet and the second packet; and
sending the third packet toward the second device.

14. The method according to claim 10, further comprising allocating, at the fabric component, a context to manage execution of the transformation function.

15. The method according to claim 10, further comprising receiving, at the fabric component, a request from the second device for the fabric component to execute the transformation function on the first data.

16. The method according to claim 10, wherein executing, at the fabric component, the transformation function on the first data to produce a second data includes selecting the fabric component, by the fabric component, to execute the transformation function on the first data.

17. The method according to claim 10, further comprising keeping, by the fabric component, a connection to the second device active while executing the transformation function on the first data.

18. The method according to claim 10, wherein:
the first packet further includes a first metadata associated with the first data; and
generating, at the fabric component, the second packet, includes generating, at the fabric component, the second packet, the second packet including the second data and a second metadata associated with the second data, the second metadata different from the first metadata.

19. A system, comprising a non-transitory storage medium, the non-transitory storage medium having stored thereon instructions that, when executed by a machine, result in:
receiving, at a fabric component of a fabric connected to a first device and a second device, a first packet originating from the first device, the first packet including a first data;
executing, at the fabric component, a transformation function on the first data to produce a second data;
generating, at the fabric component, a second packet, the second packet including the second data, the second packet different from the first packet; and
sending the second packet toward the second device.

20. The system according to claim 19, wherein:
the non-transitory storage medium has stored thereon further instructions that, when executed by the machine, result in receiving, at the fabric component, a third packet originating from the first device, the third packet including a third data; and
executing, at the fabric component, the transformation function on the first data to produce the second data includes:
executing, at the fabric component, the transformation function on the first data to produce an interim data; and
executing, at the fabric component, the transformation function on the interim data and the third data to produce the second data.
